(19) United States
(12) Patent Application Publication
(10) Pub. No.: US 2014/0222555 A1
(43) Pub. Date: Aug. 7, 2014

(54) Social Revenue Management Method

(71) Applicant: Brian Dass, Hoboken, NJ (US)

(72) Inventor: Brian Dass, Hoboken, NJ (US)

(21) Appl. No.: 14/171,900

(22) Filed: Feb. 4, 2014

Related U.S. Application Data
(60) Provisional application No. 61/760,801, filed on Feb. 5, 2013.

(51) Int. Cl. G06Q 30/02

(52) U.S. Cl. CPC G06Q 30/0247
USPC 705/14.46

(57) ABSTRACT

A system and method of social revenue management is disclosed. A member of an online social network reveals a commercial offer from a third party to their social network. The offer is customized and endorsed by the first user and typically includes details such as the price. A customization app obtained from a party outside the social network is used to create the offer.

The offer is typically to reserve a bookable entity for a period of time, typically accommodation or transportation. When one or more of the contacts accepts the offer, an agent of the third party rewards the first user with a commission calculated using the purchase price of the offer.

### CLAIM OF PRIORITY

This application claims priority of U.S. provisional application No. 61/760,801 filed on Feb. 5, 2013. The contents of the application are incorporated herein in its entirety by reference.

### FIELD OF THE INVENTION

The invention relates generally to using digital processing networks for e-commerce, and more particularly to methods for managing revenue, including agent compensation by commission, in social network facilitated, online transactions.

### BACKGROUND OF THE INVENTION

Social networks offer a tremendous opportunity for leveraging individual's “social graphs”, i.e., network of online contacts to advertise and sell commodities and business opportunities. Industries such as, but not limited to, the travel and leisure industry, particularly the accommodation segment rely heavily on word of mouth and the reviews of recent users.

One intention of the present invention is to add motivation to individuals to cash in on their experiences by providing the tools and the monitory incentives for them to act as agents for bookable entities such as, but not limited to, hotels, bed and breakfasts, cruises, tours or some combination thereof.

By providing the infrastructure to enable individuals to provide business offers from third parties in return for commissions on sales, the present invention will be of benefit both to the social network members and to the leisure industry bookable entities.

Description of the related art:

The relevant prior art includes:

U.S. Pat. No. 7,117,254 issued to Lunt, et al. on Oct. 3, 2006 entitled “Method of inducing content uploads in a social network” that describes a method of inducing content uploads in an online network that includes the steps of storing content relating to a first member of the network that is submitted by a second member of the network, receiving approval of the content from the first member, and associating the content with the first member. The uploaded content may comprise an image file containing a photo of the first member and a caption associated with the photo image. The second user uploads the content relating to the first member using a GUI. This GUI is made available to the second user through a hyperlink that appears when a profile page of the first member is accessed if the degree of separation between the first member and the second member is less than or equal to a maximum degree of separation set by the first user. On the other hand, the hyperlink to this GUI will not appear when the profile page of the first member is accessed by the second member if the degree of separation between the first member and the second member is greater than the maximum degree of separation set by the first user. The default setting for this maximum degree of separation is one.

U.S. Pat. No. 7,725,492 issued to Sittig et al. on May 25, 2010 entitled “Managing information about relationships in a social network via a social timeline” that describes a system, method, and computer program for generating a social timelines. A plurality of data items associated with at least one relationship between users associated with a social network is received, each data item having an associated time. The data items are ordered according to the at least one relationship. A social timeline is generated according to the ordered data items.

U.S. Pat. No. 7,809,805 issued to Stremel et al. on Oct. 5, 2010 entitled “Systems and methods for automatically locating web-based social network members” that describes systems and methods for automatically locating web-based social network members. According to one embodiment, contact content including an associated GPS identifier and status for web-based social network members located at or near the same location automatically appears on a GPS-enabled device. A further exemplary system includes a GPS-enabled device configured to receive a GPS identifier and a status representing a location and a current state for a web-based social network member, a processing module that associates the received GPS-identifier and the received status, and a communications module that sends the associated GPS-identifier and status to a server comprising a web-based social network database. Contact content in a web-based social network database record in the web-based social network database is updated to include the associated GPS identifier and status for the web-based social network member.

U.S. Pat. No. 7,716,287 issued to Appelman et al. on May 11, 2010 entitled “Organizing entries in participant lists based on communications strengths” that describes organizing a participant list that includes maintaining a participant list of users of an electronic communications system to be used by a first user of the electronic communications system. Communications strengths between the first user and each of the users included in the participant list are determined. The users included in the participant list are organized based on the corresponding communications strengths. Communications strengths may be determined for users included in a group within the participant list, and the users within the group may be organized within the group based on communications strength. An additional group in the participant list in which some or all of the users included in the participant list are organized based on communications strength may be provided.

Various implements are known in the art, but fail to address all of the problems solved by the invention described herein. One embodiment of this invention is illustrated in the accompanying drawings and will be described in more detail herein below.

### SUMMARY OF THE INVENTION

An inventive system and method of social revenue management is disclosed.

In a preferred embodiment, a first user may be a member of an online social network hosted on a digital electronic server. The first user may have a “social graph” that may include a list of the first user's social network contacts on the online social network. The social graph may also include social network access parameters for the contacts, and an indication of a degree of the depth of contact with each of them.

The first user may use the social graph and the social network to reveal a commercial offer from a third party to one or more of the user's social network contacts. This commercial offer may include an offer, or purchase, price and may be customized to appear to be endorsed by the first user.

If one or more of the contacts accept, or enter into, the commercial offer, the third party, or an agent of the third party may then reward the first user with a commission that may, in part, be calculated using the purchase price of the commercial offer.

In a preferred embodiment, the offer may be revealed to the first user's contacts in the form of a customized page displayed via the social network. The customized page may, for instance, be the user's home page on the social network site, or a part of their home page.

The customized page, or portion of a page, may be created using a customization app that may be obtained from a party outside the social network such as, but not limited to, a user aggregating services' server. The app may operate on the cloud, on the aggregating server, on the social network server or on the user's communication device.

The commercial offer may be an offer to reserve a bookable entity for a period of time. The bookable entity may for instance be a form of accommodation such as, but not limited to, a hotel room, a bed and breakfast, a state room on a cruise or a reservation on a tour, or some combination thereof.

Therefore, the present invention succeeds in conferring the following, and others not mentioned, desirable and useful benefits and objectives.

It is an object of the present invention to provide an easy to implement method of managing social network agencies, including setting up the opportunity and accounting for compensation.

It is another object of the present invention to provide individuals with the tools to leverage their social networks into money earning opportunities.

Yet another object of the present invention is to provide bookable entities an easy and effective way to engage individual members of social networks as their agents.

Still another object of the present invention is to provide collections of bookable entities an effective way to oversee the rental of their properties and include social network users as a part of their sales structure.

### BRIEF DESCRIPTION OF THE DRAWINGS

FIG. 1 shows a schematic implementation of a social revenue management system and method of a preferred embodiment of the present invention.

FIG. 2 shows a schematic flow chart of a social revenue management method of a preferred embodiment of the present invention. .

FIG. 3 shows a schematic overview of a social revenue management system and method of a preferred embodiment of the present invention.

### DESCRIPTION OF THE PREFERRED EMBODIMENTS

The preferred embodiments of the present invention will now be described with reference to the drawings. Identical elements in the various figures are identified with the same reference numerals.

Various embodiments of the present invention are described in detail. Such embodiments are provided by way of explanation of the present invention, which is not intended to be limited thereto. In fact, those of ordinary skill in the art may appreciate upon reading the present specification and viewing the present drawings that various modifications and variations can be made thereto.

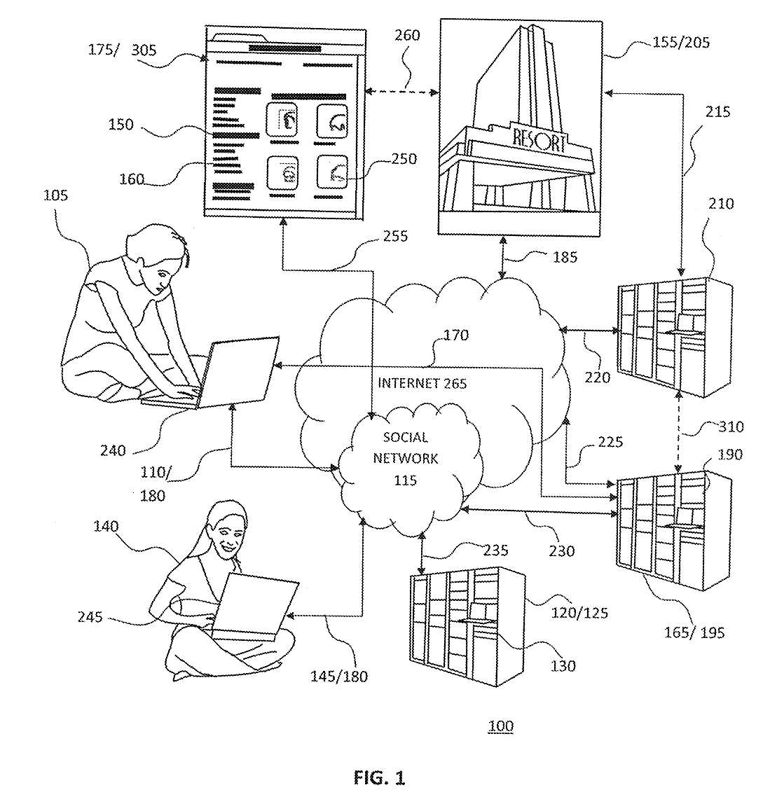

FIG. 1 shows a schematic implementation of a social revenue management system and method 100 of a preferred embodiment of the present invention.

A first user 105 may be a member of an online social network 115 that they use to maintain contact with one or more social network contacts 140. This contact is typically facilitated by the first user 105 accessing their social network homepage 305 via their communication device 240 and their membership 110 of the online social network 115. In this way they may access their social network homepage 305.

A social network contact 140 may also access the first user's 105 social network homepage 305 using their communication device 245 and their social network access parameters 145. The contact may read the messages on the first user's home page, may leave messages or may simply go to their own home page. Typically, when a user posts a message on their own home page, that message is automatically displayed on the home page of all their friends. In this way groups of online friends and easily stay in contact with each other.

Online social networks 115 typically make use of the existing Internet 265 infrastructure. In particular, an online social network 115 may be hosted by a digital electronic server 120, that by means of a set of digital instructions 130 may function as a social network server 125. The online social network 115 may be accessible via the Internet, and groups of people may interact with each other by becoming friends through a social authentication process 180 that may involve an exchange of requests to be a friend, and responses agreeing to be a friend. These exchanges may, for instance, occur by means of communication devices 240 and 245. These communication devices 240 and 245 may, for instance, be a device such as, but not limited to, a smart phone, a tablet, a laptop computer, a desktop computer or some combination thereof.

Online social networks 115 may allow for rapid dissemination of information from one trusted source to another. “Word-of-mouth” advertising may be considered to be the most effective form of advertising in the sense that people are significantly more likely to act on a recommendation from someone they know, or are familiar with, than from a stranger as is the case in many advertisements in other media such as, but not limited to, newspaper, radio and television propagated advertising. In the past, a problem with “word-of-mouth” advertising has been in aggregating sufficient initial promoters of a product to easily make it cost effective. Social networks potentially make “word-of-mouth” advertising viable as an advertising medium. The remaining challenges, however, include effective motivation for social network users to become involved, and the tools and structure to make the system easy for both users and bookable entities 205.

In a preferred embodiment, the present invention addresses these issues by providing a system of commission incentives, and the tools to implement that method.

In a preferred embodiment of the present invention, a user aggregating server 195 may offer a first user 105 a commercial offer 150 for them to post on their social network homepage 305, along with an agreement to provide the first user 105 with a commission 170 in the event that one or more of the first user's social network contacts 140 sign on to the program, i.e., agree to accept the commercial offer 150. The commercial offer 150 may, for instance, have a purchase price 160 and the commission 170 may, for instance, be based, at least in part, on that purchase price 160.

In a preferred embodiment, the bookable entity 205 may be part of a group of properties and may be managed through a booking server 210 that in turn may be in communication with a user aggregating server 195.

The user aggregating server 195 may also provide the first user 105 with a customization app 190 that may be used to set up a customized page 175 on the online social network 115. The user aggregating server 195 may reside and operate on the user aggregating server 195, the social network server 125 or the first user's communication device 240, or may function using a combination of those resources.

The customization app 190 may, for instance, include machine implementable instructions that may be operable on either the user aggregating server or said social network computer, and may be capable of creating, or assisting in the creation of a customized HTML page that may be displayed on the online social network 115. The customized page 175 so created may imply that the commercial offer 150 is endorsed by the first user 105.

The customized page 175, which may also be, but is not necessarily, the first user's 105 social network homepage 305, may also include one or more attributes 250 of the bookable entity 205. These attributes may, for instance, be multimedia content such as, but not limited to, text, images, audio or video, or some combination thereof, that may represent the advantages of the bookable entity 205. These attributes may be supplied to the customized page 175 via the Internet 265 by, for instance, using an Internet link 185 associated with the bookable entity 205 and a link 255 from the social network to the customized page 175. The attributes may also, or instead, be supplied via a direct link 260 from the bookable entity 205 to the customized page 175.

The bookable entity 205, which may be considered as a third party 155 in the transaction, may, for instance, be managed by a booking server 210, either via a direct link 215 between the booking server 210 and the bookable entity 205, or via the Internet 265 using a booking server Internet link 220 and the Internet link associated 185 with the bookable entity 205.

The booking server 210 may be in communication with the user aggregating server 195, which may be considered to be the agent 165 of the third party 155. This communication may, for instance, be via a direct link 310 between the user aggregating server 195 and the booking server 210. The communication may also, or instead, be via a user aggregating server Internet link 225 and a booking server Internet link 220.

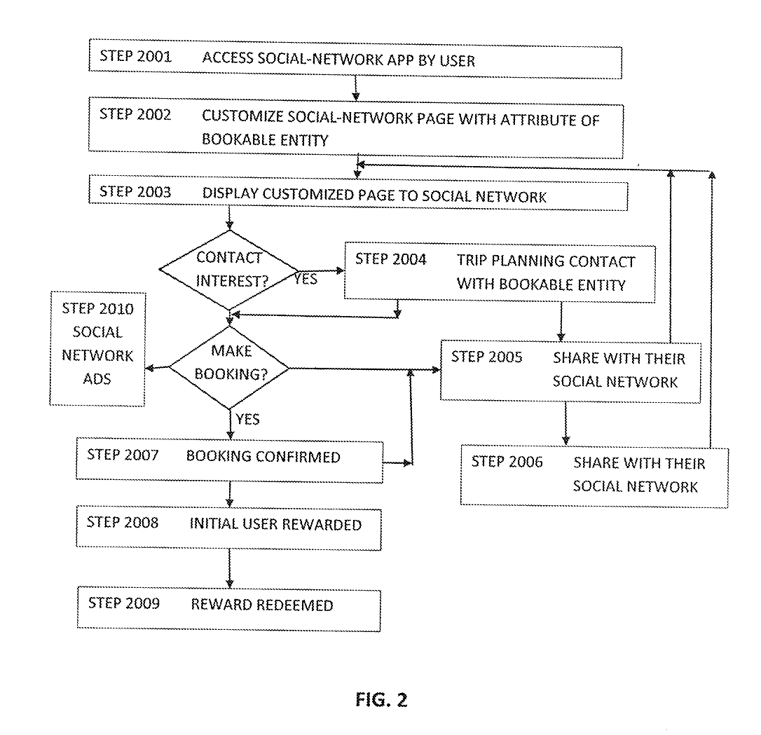

FIG. 2 shows a schematic flow chart of a social revenue management method of a preferred embodiment of the present invention.

In Step 2001, a user may access a social network app.

In Step 2001, the social network app, which may be operable on the cloud, on a server such as, but not limited to, the social network server, the aggregator server, or a user computing device or some combination thereof, may be used to customize a social network page with one or more attributes of a bookable entity as shown in Step 2002. These attributes may, for instance, include multi-media items showing the benefits of the bookable entity such as, but not limited to, photographic, audio or video, or some combination thereof. The attributes may also, or instead, provide details of the price, or cost of booking the bookable entity for a period of time. The attributes may also, or instead provide a URL, or Internet link, of a webpage that may supply some, or all, of the information described above. The Internet link may, for instance, be a part of, or associated with, the commercial offer revealed on the customized social network page.

In Step 2003, the user may display, or reveal, the customized page to other members of the social network. Typically a user would reveal the offer to their network of friend on the social network, as those are the people that they have formed some degree of interaction with, including having authorized them to be friends via a social authentication process that typically would have included sending or receiving an electronic request that included a name, and of sending an electronic acknowledgement accepting the request to be friends.

One or more of the user's friend or contacts may be interested in the commercial offer of the third party, or bookable entity. That user may then, in Step 2004, enter directly into discussions with the third party concerning the commercial offer. In a preferred embodiment of the present invention, the friend or contact may begin a process of trip or vacation planning by contacting the bookable entity behind the commercial offer directly.

The interested contact may also proceed to step 2005 and share the commercial offer with their network of social media friends. The interested contact may also, or instead, share their interest in the commercial offer with one or more of their network of social media friend.

The interested contact may then make a booking. This may include acceptance of a commercial offer available from a third party via the first user. In a preferred embodiment, the acceptance may be agreeing to an arrangement such as, but not limited to, renting a particular unit of accommodation for a particular period of time for a particular number of guests, for a particular price, or some combination thereof.

If a booking is made, the booker may then proceed to step 2005 and share some or all of the details of their booking with their social network contacts. These social network contacts may then go to step 2003 and examine the commercial offer displayed on the customized network. They may also, or instead, proceed to Step 2006 and share the information with their social network friends, who may also proceed to Steep 2003.

The third party, or bookable entity, may also use the opportunity of a booking being made to publicize it by going to Step 2010 and purchasing, or otherwise, initiating an ad to be displayed on one or more home pages of the social network.

In Step 2007, the booking may be confirmed. This may be a further opportunity for the contact making the booking to go to Steep 2005 and share this news with one or more of their social network.

In Step 2008, the initial user may be rewarded. In a preferred embodiment, this may take the form of the first user being paid a commission that may be calculated entirely or in part on the price the contact paid to book the bookable entity, or participate in the commercial offer, and may, for instance, be paid in cash or a cash equivalent. The reward may be paid directly by the third party, or bookable entity, or by an agent of the third party such as, but not limited to, the client aggregator. The commission may be transacted over the Internet or via any standard method of payment such as, but not limited to, a bank wire transfer, a check, a PayPal account or some combination thereof.

The commission may also, or instead, be paid wholly or partly, in the form of a benefit such as, but not limited to, a discount on a similar booking, a coupon that may be redeemed for similar or related services, a refund of all or part of a previously paid expense, or some combination thereof.

In Step 2009, the first used may redeem their reward. This may take the form of an action such as, but not limited to, cashing a check, booking a bookable item at a discount, or some combination thereof.

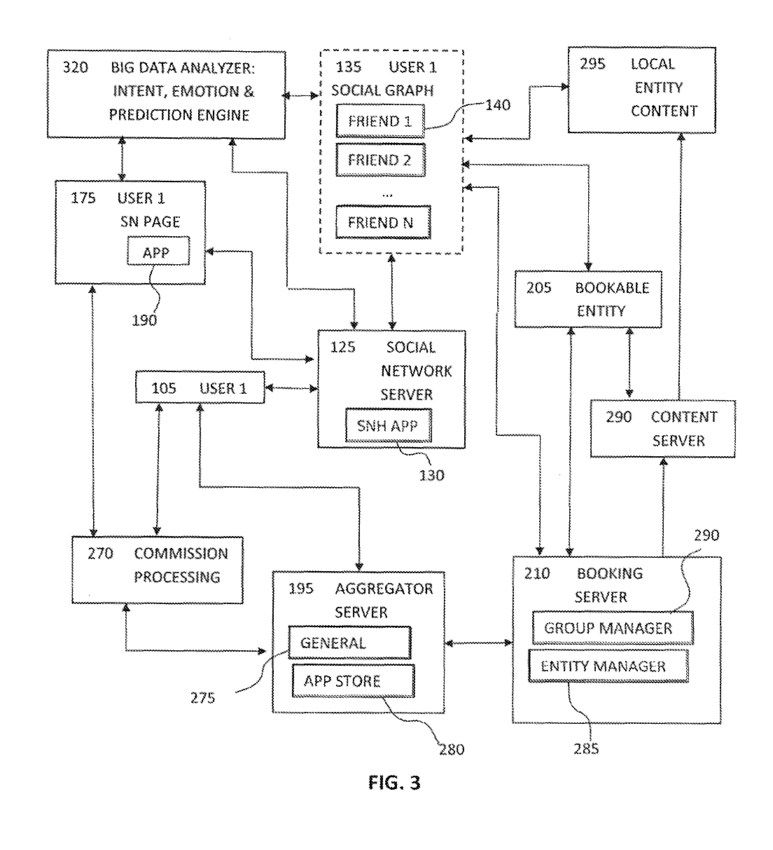

FIG. 3 shows a schematic overview of a social revenue management system and method of a preferred embodiment of the present invention.

A first user 105 may obtain a commercial offer from a general purpose module 275 of a user aggregating server 195. The first user 105 may also go to an app store 280 that may also be resident on the user aggregating server 195 and obtain a customization app 190.

User 1 may then log onto their home page on a social network facilitated by a set of digital instructions 130 operable on a social network server 125. The first user 105 may use the customization app 190 to create a customized page 175 that may include a commercial offer from a third party 155, that may for instance contain details of the offer such as, but not limited to, a purchase price, an starting date for the offer, an expiry date for the offer or some combination thereof.

The commercial offer may, for instance, be an opportunity to rent, for a fixed time at a fixed price a bookable entity 205 such as, but not limited to, accommodation, transport, services or some combination thereof. The customized page 175 may display the price of such rentals and/or provide a URL to a website that may have these and other details of the offer.

The first user may then reveal the customized page 175 to the first user's social graph 135, beginning with their own social network contacts 140, who may then reveal the customized page to their own network contacts, with the process repeating itself as long as there is sufficient interest in the customized page 175 for the recipients to repost a link or reference to the customized page 175.

This revealing of the offer to the user's social graph may be facilitated by the social network server 125 that may a digital electronic server made operable as a social network server by a set of appropriate digital instructions 130.

One of the first user's social network contacts 140 and may contact the bookable entity 205 for further information. This further information may be supplied by the bookable entity 205 or may be relayed on via a content server 290 that may be associated with a booking server 210. The content server 290 may also provide local entity content 295 that may be accessed directly by the interested social network contact 140.

The interested social network contact 140 may then decide to participate in the commercial offer and make a booking. The booking may be made directly via the bookable entity 205 or the booking server 210 or some combination thereof. The booking may, for instance, be made with the bookable entity 205, relayed on to the booking server 210 who may then send a confirmation on to the social network contact 140 and details of the booking on t the user aggregating server 195. Similarly payment may be made to either the bookable entity 205 or the booking server 210 or some combination thereof, as when a deposit may be paid to one and the final amount to the other. The user aggregating server 195 may then pass the relevant information on to a third party such as a commission processing module 270 or service. The commission processing module 270 may then cause the first user 105 to be credited with the appropriate commission. The commission may, for instance, be a reward such as, but not limited to, a cash amount that may be related to the purchase price the social network contact 140, a reduction on a future purchase by the first user, a full or partial refund of a previous purchase by the first user, coupons or points as part of a reward scheme, or some combination thereof. The commission may be sent directly to the first user 105 or may be routed to them via their customized page 175, or social network home page, or a combination thereof. Notification of the commission may for instance be made via the customized page 175 and actual payment directly to the user, or their designated agent such as, but not limited to, a bank, a PayPal account, or some combination thereof.

A big data analyzer 320 may also be a part of the social revenue management. The big data analyzer may, for instance, reside on a server in the cloud and may have access to large data sets such as, but not limited to, real-time data from social media, blogs, emails, sensor data, including camera data and position sensing data, or some combination thereof.

The big data analyzer may, for instance, be capable of searching, querying and analyzing these large data sets in real-time. The analysis may, for instance, be done by specially programmed modules.

One such module, may, for instance, be an intent engine that may be programmed to parse online conversations and detect mention of a particular product in a conversation by particular social media user, and thereby associate that product with that user. The intent engine may also detect further words or phrases within the conversation, or related conversation and make a determination of the level of a user's intent to buy the associated product. The intent engine may quantify this intent with a rating on a suitable scale such as, but not limited to, a linear scale from 1 to 10, or 1 to 5.

Another such module that may be operative on the big data analyzer may, for instance, be an emotion engine. The emotion engine may also be programmed to parse online conversations to detect a user and an associated product, but may instead use some further words or phrases detected within the conversation to provide a rating of a degree of liking of the product by the social media user.

A further such module that may be operative on the big data analyzer may, for instance, be a prediction engine. The prediction engine may also be programmed to parse online conversations to detect a user and an associated product, but may instead use some further words or phrases detected within the conversation to provide a rating of a likely hood that the user will buy the product within a predefined time, such as, but not limited to, the next ten minutes, the next hour, the next day or within the next week, or some combination thereof.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed:

1. A social revenue management method, comprising:
providing a first user having a membership of an online social network hosted on a digital electronic server programmed by a set of digital instructions to function as a social network server;
providing, by said first user, a first user's social graph comprising said first user's social network contacts on said online social network, and social network access parameters for said social network contacts;
revealing, by said first party, to one or more of said social network contacts via said social network, a commercial offer from a third party, said commercial offer comprising a purchase price and being customized to appear to be endorsed by said first user, and
receiving, by said first user from an agent of said third party, on one or more of said social network contacts accepting said commercial offer, a commission calculated using said purchase price.

2. The method of claim 1 wherein revealing said commercial offer further comprises displaying a customized page on said online social network.

3. The method of claim 2 wherein said first user's social network contacts have been authenticated by said first user via a social authentication process comprising a name and an electronic request from each of said first user's social network contacts.

4. The method of claim 3 wherein said commercial offer further comprises an Internet link associated with said offer.

5. The method of claim 3 wherein creating said customized page further comprises using a customization app accessed from a user aggregating server, said customization app comprising machine implementable instructions operable on either said user aggregating server or said social network computer to create a customized HTML page.

6. The method of claim 5 wherein said commercial offer comprises an offer to reserve a bookable entity for a period of time.

7. The method of claim 6 wherein said customized page further comprises at least one attribute of said bookable entity conveyed to said customized page by one of said bookable entity, said user aggregating server and said booking server.

8. The method of claim 1 further comprising a big data analyzer comprising an intent engine programmed to parse online conversations and associate a product and a social media user with a rating of said user's intent to buy said product.

9. The method of claim 8 wherein said big data analyzer further comprises an emotion engine programmed to parse online conversations and associate a rating of a degree of liking to said product by said social media user; and a prediction engine programmed to parse online conversations and associate a rating of a likely hood that said user will buy said product within a predefined time.
